(19) United States
(12) Patent Application Publication
(10) Pub. No.: US 2025/0024411 A1
(43) Pub. Date: Jan. 16, 2025

(54) WIRELESS-BASED SIDELINK POSITIONING METHOD AND APPARATUS

(71) Applicant: ZTE CORPORATION, Shenzhen (CN)

(72) Inventors: Chuangxin JIANG, Shenzhen (CN); Qi YANG, Shenzhen (CN); Junpeng LOU, Shenzhen (CN); Mengzhen LI, Shenzhen (CN); Juan LIU, Shenzhen (CN); Youxiong LU, Shenzhen (CN)

(21) Appl. No.: 18/714,333

(22) PCT Filed: Apr. 8, 2022
(86) PCT No.: PCT/CN2022/085736

§ 371 Date: May 29, 2024

(51) Int. Cl. H04W 64/00; H04L 5/00; H04W 72/02; H04W 92/18

(52) U.S. Cl. CPC H04W 64/00; H04L 5/0051; H04W 72/02; H04W 92/18

(57) ABSTRACT

In one aspect a method of wireless communication is disclosed. The method includes determining, by a wireless device, a sidelink positioning reference signal configuration message and a sidelink communication configuration message, and determining, by the wireless device, a sensing duration for a sidelink communication transmission based on at least the sidelink positioning reference signal configuration message. The method further includes performing sensing or transmit resource selection for the sidelink communication transmission and performing another transmit resource selection for a sidelink positioning reference signal transmission, wherein a plurality of sidelink positioning reference signal occasions are scheduled by one sidelink communication occasion.

### TECHNICAL FIELD

This patent disclosure is directed to wireless communications.

### BACKGROUND

Positioning services are very common among users in indoor and outdoor environments. In outdoor environments, the global positioning system (GPS) can be used for positioning. In indoor environments, GPS signal power may be too low to get an accurate, or any, positioning estimate. Wireless positioning solutions can be used as well, using time difference-based positioning. New techniques are needed to more accurately position wireless devices in indoor and outdoor environments.

### SUMMARY

Methods, apparatuses, and computer readable media for wireless communication are disclosed.

In one aspect a method of wireless communication is disclosed. The method includes determining, by a wireless device, a sidelink positioning reference signal configuration message and a sidelink communication configuration message, and determining, by the wireless device, a sensing duration for a sidelink communication transmission based on at least the sidelink positioning reference signal configuration message. The method further includes performing sensing or transmit resource selection for the sidelink communication transmission and performing another transmit resource selection for a sidelink positioning reference signal transmission, wherein a plurality of sidelink positioning reference signal occasions are scheduled by one sidelink communication occasion.

The following features can be included in various combinations. The sensing duration corresponds to a quantity of sidelink communication occasions or a sensing time duration. A first interval between successive sidelink communication occasions is determined by at least a second interval between the successive sidelink positioning reference signal occasions, or the second interval between the successive sidelink positioning reference signal occasions is determined by at least the first interval between the successive sidelink communication occasions. One or more of: the first interval is equal or smaller than the sensing duration, the first interval is larger than the second interval, the first interval is a multiple of the second interval, or a first interval value has a one-to-one mapping to a second interval value. The method further includes determining a maximum interval, T_{SCI-PRS}, between a sidelink communication occasion and a last one of the plurality of sidelink positioning reference signal occasions scheduled by the sidelink communication occasion based on preconfiguration of a configuration message. The maximum interval, T_{SCI-PRS}, is equal to or less than the sensing duration or a first interval between successive sidelink communication occasions. The performing sensing and transmit resource selection for a sidelink communication occasion is determined by whether the sidelink communication triggers a sidelink positioning reference signal. The sensing duration for a first sidelink communication is preconfigured or configured without triggering the sidelink positioning reference signal and a second sidelink communication with triggering the sidelink positioning reference signal are separate. Separate candidate interval values between successive sidelink communication occasions are preconfigured or configured for a first sidelink communication without triggering sidelink positioning reference signal and a second sidelink communication with triggering sidelink positioning reference signal. Candidate sensing occasions for a sidelink communication resource selection with scheduling SL-PRS is a subset of the candidate sensing occasions for the sidelink communication resource selection without scheduling SL-PRS. Partial periodic sensing is operated at least a time, T_{SCI-PRS}, before a potential SL-PRS selection occasion scheduled by a potential sidelink communication selection occasion or before a slot triggering a selection procedure or before a potential sidelink communication selection occasion scheduling the SL-PRS selection occasion. T_{SCI-PRS} is preconfigured for each resource pool of sidelink communication or for each interval value between the successive sidelink communication occasions or for each PRS configuration or for each SL-PRS period value. The sensing duration is equal or longer than T_{SCI-PRS}. The method further includes determining, by the wireless device, a subset of SL-PRS configurations for sensing, or determining a sidelink communication time or frequency configuration scheduling SL-PRS for sensing based on preconfiguration or a configuration message, wherein a full set of SL-PRS configurations is determined to be unavailable according to the sensing result for the subset. The configuration includes one or more of: SL-PRS symbols in one SL-PRS resource, frequency resources in each SL-PRS symbol, or resources in one SL-PRS resource set.

### BRIEF DESCRIPTION OF THE DRAWINGS

FIG. 1A shows a time difference of arrival (TDOA) positioning method and positioning reference signal (PRS) pattern. in accordance with some example embodiments.

FIG. 1B shows an example operational scenario with multiple user equipment (UEs), roadside units (RSUs), and base stations.

FIG. 2A shows an example of a sidelink (SL) mode resource sensing and selection for a resource pool.

FIG. 2B shows an example of SL scheduling for a physical sidelink shared channel (PSSCH) triggered by sidelink control information (SCI).

FIG. 2C shows an example of SL-PRS occasions tied with a PSCCH/PSSCH.

FIG. 2D shows an example of a physical sidelink control channel (PSCCH)/PSSCH triggering a number of SL-PRS occasions.

FIG. 2E shows an example a sensing window for SL-PRS scheduling with no PSCCH/PSSCH present.

FIG. 2F shows an example of a sensing operation for a SL-PRS transmission.

FIG. 3 shows an example of a subset of resources of PSCCH/PSSCH for scheduling SL-PRS.

FIG. 4A shows an example of partial sensing.

FIG. 4B shows an example of partial sensing considering the scheduling of SL-PRS which may collide with the PSCCH/PSSCH resource.

FIG. 4C shows an example of partial sensing considering scheduling of SL-PRS.

FIG. 4D shows an example of partial sensing considering scheduling of SL-PRS with a sensing length equal or larger than T_{SCI-PRS}.

FIG. 5A shows another example of partial sensing for SL-PRS.

FIG. 5B shows another example of partial sensing for SL-PRS.

FIG. 6 depicts an example of a process.

FIG. 7 shows an exemplary block diagram of a hardware platform that may be a part of a communication device.

FIG. 8 shows an example of wireless communication including a base station (BS) and user equipment (UE) based on some implementations of the disclosed technology.

### DETAILED DESCRIPTION

Section headings are used in the present document to improve readability and do not limit scope of the disclosed embodiments and techniques in each section to only that section. Certain features are described using 3GPP terminology but may be practices in other wireless systems that use other wireless communication protocols.

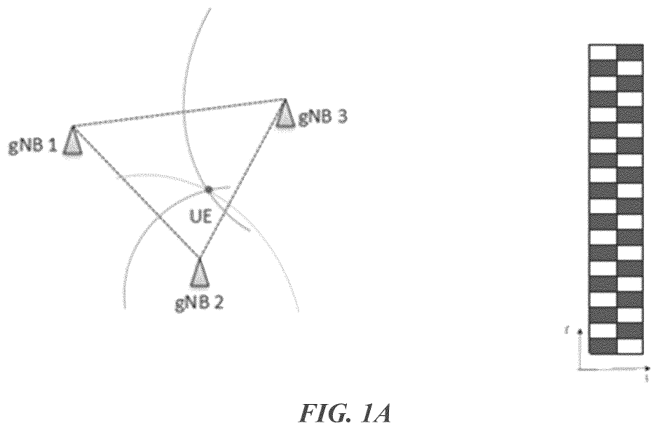

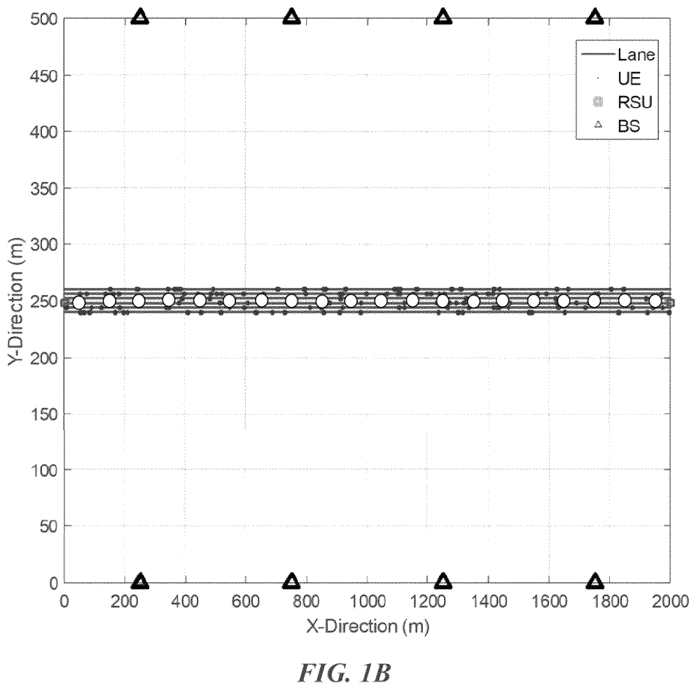

3GPP introduces radio access technology (RAT) dependent positioning methods including multi cell round trip time (multi-RTT), time difference of arrival (TDOA), angle of arrival (AoA)/angle of departure (AoD) based positioning methods, etc. For downlink (DL) position measurement, multiple transmission/reception points (TRPs) transmit positioning reference signals (DL-PRS), and the user equipment (UE) determine position measurement results using the various positioning methods, then a location management function (LMF) or the UE can calculate the UE location or position. The measurement results may include arrival time differences between the UE and multiple TRPs, reference signal received power (RSRP), UE receive (Rx)-transmit (Tx) time difference and so on. For the uplink (UL), the UE can transmit sounding reference signal (SRS) or SRS for positioning (UL-PRS or positioning SRS) to multiple TRPs, and TRPs can determine the UL measurement results, then the LMF or UE can calculate the UE location based on the measurement results. An illustration of an example TDOA positioning method is shown in FIG. 1A where several next generation node B (gNBs) or TRPs transmit PRS to the same UE. The UE can measure the distance differences between the UE and the different gNBs/TRPs. The crossed point (dot) in the FIG. 1A is an estimate of the UE location. The right side of FIG. 1A shows an example of a two-symbol PRS pattern. Each gNBs/TRPs can transmit the same or different PRSs at the same or a different time according to the higher layer configuration.

TDOA and multi-RTT positioning methods use timing-based positioning solutions and the location accuracy relies on line-of-sight (LOS) paths between the UE and the TRPs. That is, if there are not sufficient number of TRPs having LOS paths to the UE, the positioning accuracy will be degraded. Usually, whether a LOS path exists in a propagation channel between a UE and a TRP relies on multiple factors including the distance between the UE and the TRP, obstacles between UE and the TRP, etc. For instance, the larger distance between the UE and the TRP, the lower probability of a LOS path.

In actual deployments, gNBs or TRPs are generally installed in limited locations due to cost. For instance, in an urban scenario, the inter-TRP interval is typically 200 m or more. This leads to the UE possibly having LOS paths with only one or two nearby TRPs since the UE may be too far away from other TRPs.

As shown in FIG. 1B, the dots represent UEs, the open circles represent roadside units (RSUs), and the triangles represent base stations (gNBs or TRPs). FIG. 1B shows UEs positioned along a roadway, for example, which may have a distribution of UEs associated with the cars on the roadway. These UEs may have sidelink capability for facilitating positioning the UEs. In some example embodiments, an RSU is a UE that includes sidelink capability for transmitting/receiving positioning reference signals. As we can be seen, because TRPs in the example of FIG. 1B are too far away from the UEs, the LOS probability between UEs and TRPs will be low.

For example, a roadway that may have multiple lanes that may correspond to a tunnel. UEs in the tunnel may not be able to access the network of TRPs. Hence, the traditional wireless based positioning, e.g., TDOA, Multi-RTT may not work because no wireless signal is present between the UE and the TRPs.

To aid in solving the problem of a lack of wireless connectivity in a tunnel, rural area, or other wireless limited environment, RSUs can be deployed along the sides of freeways, tunnels, etc. If a positioning reference signal can be transmitted from the RSUs to the UEs in the cars, or from the UEs in the cars to RSUs, positioning methods using RSUs and the regular UEs can be used. Even if the locations of RSUs are unknown, the relative distance among UEs can be estimated.

Below are several examples to illustrate the disclosed subject matter. Features from the various examples may be combined in some example embodiments.

### Example 1

Sidelink positioning reference signals (SL-PRS) can be used in positioning method(s) between UEs. In example embodiments, some UEs may not be under control of the network. In this case, the rules to trigger, transmit, and receive SL-PTRS between UEs should be determined in order to support measurement accuracy without the presence of SL-PRS signal collisions.

In some example embodiments, to avoid sidelink (SL) resource collisions, the interval between the scheduling PSCCH/PSSCH and the last one of X of the scheduled SL-PRS can be restricted. The interval may be equal to or smaller than a threshold time interval, T_{SCI-PRS}, which is preconfigured or configured. As used herein, preconfigured means the thing preconfigured is determined without requiring interaction with another device. For example, the threshold can be preconfigured or configured to be the sensing window size or the threshold can be P_{rsvp_PRS}.

Alternatively, the sensing length (duration) Lₛₑₙₛₑ or the number of sensing occasions Nₛₑₙₛₑ is determined by T_{SCI-PRS}. T_{SCI-PRS} can be preconfigured or configured for each resource pool or for each PRS configuration or for each SL-PRS period value.

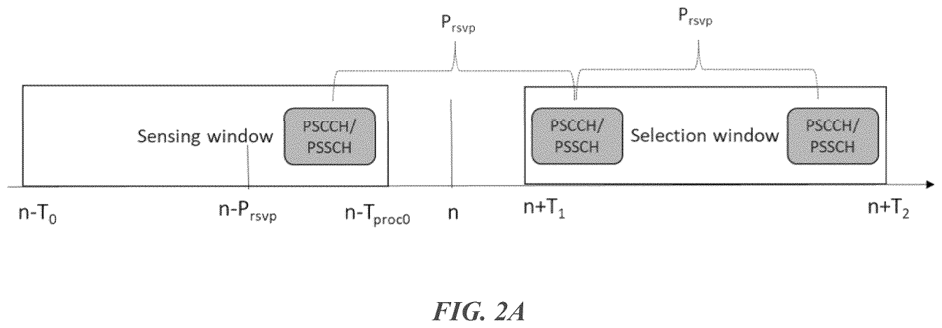

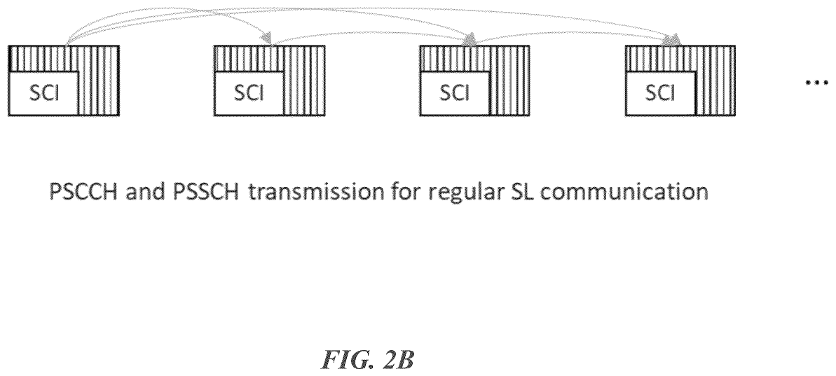

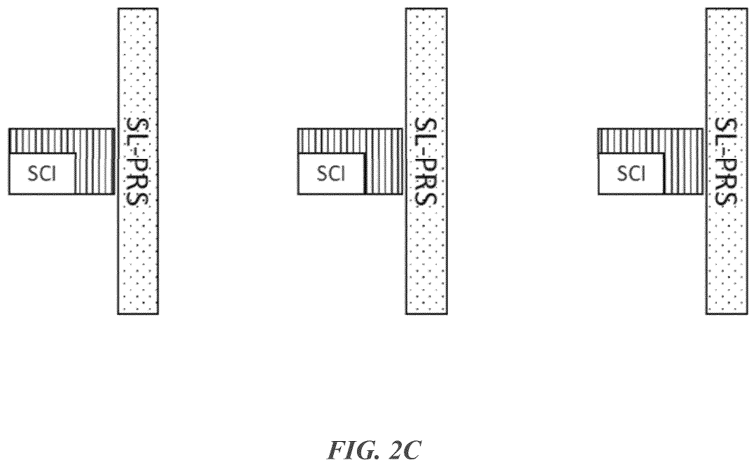

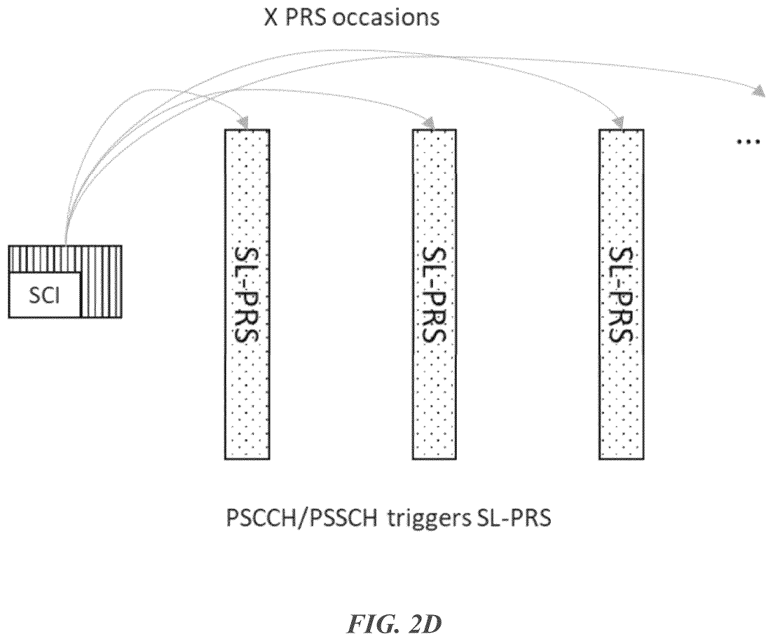

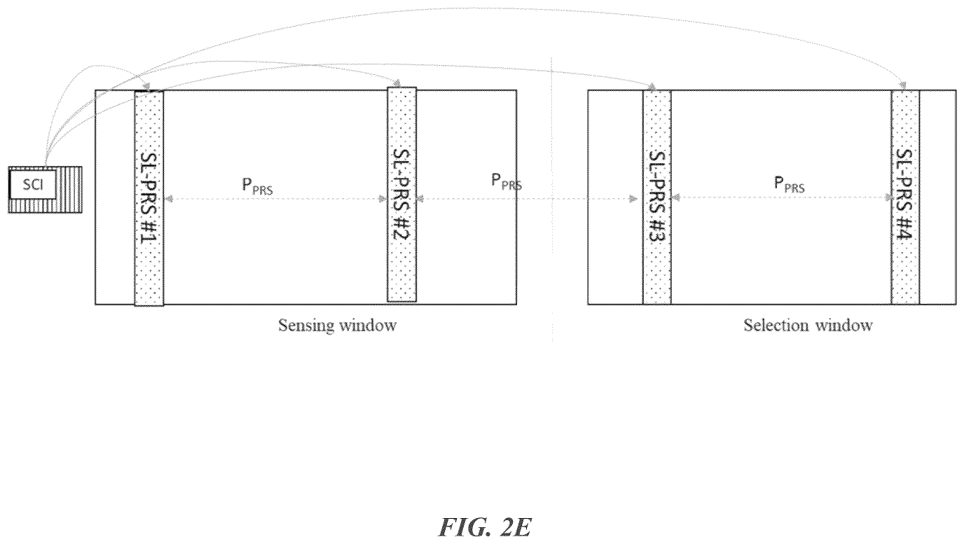

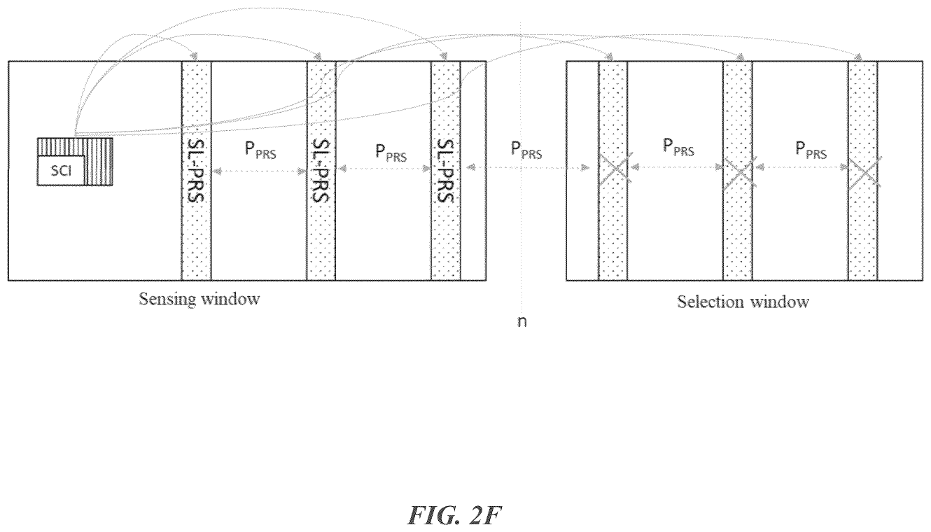

As shown in FIG. 2A, in resource allocation mode 2, the higher layer can request the UE to determine a subset of resources from which the higher layer will select resources for PSSCH/PSCCH transmission. To trigger this procedure, in slot n, the UE has to do sensing in the sensing window, and further select the candidate resource for transmission in the selected window based on the sensing results.
1) A candidate single-slot resource for transmission R_{x,y} is defined as a set of L_{subCH} contiguous sub-channels with sub-channel x+j in slot t′_{y}^{SL} where j=0, . . . , L_{subCH}−1. The UE may use that any set of L_{subCH} contiguous sub-channels included in the corresponding resource pool within the time interval [n+T₁, n+T₂] correspond to one candidate single-slot resource, where
   selection of T₁ is up to the UE implementation under 0≤T₁≤T_{proc,1}^{SL}, where T_{proc,1}^{SL} is defined in the SL BWP;
   if T₂ₘᵢₙ is shorter than the remaining packet delay budget (in slots) then T₂ is up to the UE implementation subject to T₂ₘᵢₙ≤T₂≤remaining packet delay budget (in slots); otherwise T₂ is set to the remaining packet delay budget (in slots).
2) The sensing window is defined by the range of slots [n−T₀, n-T_{proc,0}^{SL}) where T₀ is defined above and T_{proc,0}^{SL} is defined in the SL BWP. The UE shall monitor slots which belongs to a sidelink resource pool within the sensing window except for those in which its own transmissions occur. The UE can perform the following steps based on decoded PSCCH and RSRP measured in these slots.
a. Pᵣₛᵥₚ is the potential resource reservation period for PSCCH and PSSCH transmission. The candidates of Pᵣₛᵥₚ are preconfigured or configured by higher layer signaling.

For example, if UE1 detects a PSCCH/PSSCH from UE2 in the sensing window where the PSCCH/PSSCH enables a periodic resource reservation with period Pᵣₛᵥₚ, and the PSSCCH/PSSCH has higher priority and/or larger receive RSRP, that is to say, the corresponding PSCCH/PSSCH resources in the selection window may not be available for the UE1's SL transmission. Hence, the candidate single-slot resource for transmission R_{x,y} does not contain the PSCCH/PSSCH resources in the selection window as shown in FIG. 2A to avoid the transmission collision between UE1 and UE2.

For SL data transmission, each PSSCH occasion should be triggered by a PSCCH or a SCI as shown in FIG. 2B. In the sensing window, once the UE1 detects a PSCCH from a UE2, it will know all the scheduling PSSCH resources occupied or reserved by the UE2 in the selection window as PSSCH and PSCCH are always transmitted together. This design makes sensing operation easier as UE 1 only needs to detect SCI/PSCCH from another UEs.

For SL-PRS transmission, each SL-PRS transmission occasion can be tied to a PSCCH/PSSCH as shown in FIG. 2C. In such a case, the UE may detect/sense SCI in the sensing window, without performing sensing for SL-PRS because the SL-PRS configuration including SL-PRS periodicity, time and/or frequency domain resources, sequence ID, etc. are carried by the PSCCH/PSSCH information.

Resource waste can occur due to SL-PRS being transmitted periodically. To reduce PSCCH/PSSCH resource overhead, a single PSCCH/PSSCH can schedule multiple occasions of SL-PRS transmissions as shown in FIG. 2D where the number of PSCCH/PSSCH occasions is less than X.

Shown in FIG. 2E are several SL-PRS occasions that are transmitted in the sensing window with the scheduling PSCCH/PSSCH is outside the sensing window. In this case, if UE1 is not able to detect the PSCCH/PSSCH transmitted from UE2, then it may not know the SL-PRS configuration, and may further transmit SL-PRS in the resources overlapping with SL-PRS #3 and #4 from the UE2. As a result a transmission collision may happen and a positioning measurement may not be performed between the UE1 and UE2.

A solution is for one PSCCH/PSSCH to schedule a quantity, X, SL-PRS instances or occasions or occasions of periodicities and set up the association among at least two of:
a) periodicity P_{rsvp_PRS} of PSCCH/PSSCH scheduling SL-PRS or the interval P_{rsvp_PRS} between two PSCCH/PSSCH scheduling SL-PRS
This ensures P_{rsvp_PRS} is equal or smaller than the sensing window size. At least one PSCCH/PSSCH will be present in the sensing window if SL-PRS is transmitted in the sensing window. So, the UE is able to detect in the sensing window the corresponding PSCCH/PSSCH or SCI which schedules the periodic SL-PRS. After the UE successfully detects the PSCCH/PSSCH or SCI as shown in FIG. 2F, UE1 will know the PSCCH/PSSCH or SCI from an another UE2 schedules a periodic SL-PRS and then the last three SL-PRS resources in the selection window will not be available for the UE1's SL-PRS transmission.
b) The sensing window size Wₛ. or sensing duration
Wₛ can be the length from n-T₀ to n or n-T₀ to n-T_{proc0}. P_{rsvp_PRS} should be equal or smaller than Wₛ
c) The periodicity of SL-PRS P_{PRS}
i) One specific solution is that, the candidate values of P_{rsvp_PRS} can be multiple of the candidates of P_{PRS}, e.g., all or some of P_{rsvp_PRS} values can be X times of all or some P_{PRS} values.
ii) Another example, all or some of P_{rsvp_PRS} values can be larger than X times of all or some of P_{PRS} values
iii) Another example is, associate P_{PRS} with P_{rsvp_PRS}. One or more following relationship should be satisfied:
a) P_{rsvp_PRS}>=Pᵣₛᵥₚ or P_{rsvp_PRS}>=P_{PRS}
b) associate each value of P_{PRS} with each value of P_{rsvp_PRS}, e.g., one-to one mapping. For example, the value of P_{rsvp_PRS} is larger than the associated P_{PRS} or Pᵣₛᵥₚ. For example, the value of P_{rsvp_PRS} is multiple of the associated P_{PRS} or Pᵣₛᵥₚ. For another example, the value of P_{rsvp_PRS} is larger than multiple of the associated P_{PRS} or Pᵣₛᵥₚ for the foregoing cases, X>=1, and one SL-PRS instance means the SL-PRS occasion(s) are within one SL-PRS periodic instance. The interval between two successive occasions refers to periodicity. In some example embodiments, a first interval between the successive sidelink communication occasions is determined by at least a second interval between the successive sidelink positioning reference signal occasions, or the second interval between the successive sidelink positioning reference signal occasions is determined by at least the first interval between the successive sidelink communication occasions. The interval between two successive sidelink communication occasions refers to periodicity Pᵣₛᵥₚ. The interval between the successive sidelink positioning reference signal occasions is peridoicy of SL-PRS.

Another solution is to restrict that the interval between the scheduling PSCCH/PSSCH and the last one of X scheduled SL-PRS equal to or smaller than a threshold T_{SCI-PRS} which is preconfigured or configured, for example, the threshold is the same as or determined by the sensing window size or sensing duration. The first symbol of the PSCCH/PSSCH and the last symbol of the scheduled SL-PRS are equal to or smaller than the sensing window size or sensing duration. In some cases, the threshold is P_{rsvp_PRS}.

### Example 2

As shown in FIG. 2A for PSCCH/PSSCH resource determination without considering SL-PRS scheduling, the UE shall exclude any candidate single-slot resource R_{x,y} from the set S_{A} if it meets all the following conditions:
a) the UE receives an SCI format 1-A in slot t′ₘ^{SL}, and a ‘Resource reservation period’ field, if present, and ‘Priority’ field in the received SCI format 1-A indicate the values P_{rsvp_RX} and prio_{RX}, respectively according to Clause 16.4 in [6, TS 38.213];
b) the RSRP measurement performed, according to clause 8.4.2.1 for the received SCI format 1-A, is higher than Th(prio_{RX}, prio_{TX});
c) the SCI format received in slot t′ₘ^{SL} or the same SCI format if the ‘Resource reservation period’ field is present in the received SCI format 1-A, is assumed to be received in slot(s) t′_{m+q×P′}_{_{rsvp_RX}}^{SL} determines according to clause 8.1.5 the set of resource blocks and slots which overlaps with R_{x,y+j×P′}_{_{rsvp_TX}}, for q=1, 2, . . . , Q and j=0, 1, . . . , Cᵣₑₛₑₗ−1. Here, P′_{rsvp_RX} is P_{rsvp_RX} converted to units of logical slots according to clause 8.1.7, Q=┌t_{scal}/P_{rsvp_RX}┐ if P_{rsvp_RX}<T_{scal} and n′−m≤P′_{rsvp-RX}, where t′_{n′}^{SL}=n if slot n belongs to the set (t′₀^{SL}, t′₁^{SL}, . . . , t′_{T′max-1}^{SL}), otherwise slot t′_{n′}^{SL} is the first slot after slot n belonging to the set (t′₀^{SL}, t′₁^{SL}, . . . , t′_{T′max-1}^{SL}); otherwise Q=1. T_{scal} is set to selection window size T₂ converted to units of msec.

For PSCCH/PSSCH resource determination without considering SL-PRS scheduling, the UE may try to do sensing between slot n-Pᵣₛᵥₚ and n where slot n can be either absolute slot or logic slot number in the corresponding resource pool. Alternatively, the UE may try to do sensing between slot n′-P′ᵣₛᵥₚ and n′ (real sensing window) where n′ or P′ᵣₛᵥₚ are numbered in the logic slots. This design is for power saving as it is unnecessary for the UE to do sensing before n-Pᵣₛᵥₚ or n′-P′ᵣₛᵥₚ.

For PSCCH/PSSCH resource determination with considering SL-PRS scheduling, the above solution may not be workable if the PSCCH/PSSCH scheduling SL-PRS is just transmitted between n-T0 and n-Pᵣₛᵥₚ but not between n-Pᵣₛᵥₚ and n. If the UE follows the design for PSCCH/PSSCH resource determination without considering SL-PRS scheduling, the UE may miss the detection of the PSCCH/PSSCH between n-T0 and n-Pᵣₛᵥₚ for SL-PRS scheduling.

To avoid this issue, one solution is to preconfigure or configure at least two sets of the candidates of Pᵣₛᵥₚ or P′ᵣₛᵥₚ where one set refers to the candidates of resource reservation period for PSCCH and/or PSSCH transmission without scheduling SL-PRS, another set refers to the candidates of resource reservation period for PSCCH and/or PSSCH transmission which is able to schedule SL-PRS. The two types of resource reservation period for PSCCH and/or PSSCH transmission corresponding to with and without SL-PRS scheduling can be denoted as P_{rsvp_data} and P_{rsvp_prs} respectively for discussion purpose.

Assuming a PSCCH/PSSCH can only schedule either SL-data or SL-PRS but not both, the value of P_{rsvp_prs} should be associated with or determined by or relying on the period(s) of SL-PRS. Specifically, P_{rsvp_prs} is equal or larger than the period of SL-PRS. More specifically, there may be at least one of the following principles:
The minimum value of candidates of P_{rsvp_prs} is equal to or larger than the minimum value of candidates of SL-PRS period.
The minimum value of candidates of P_{rsvp_prs} is equal to or larger than the maximum value of candidates of SL-PRS period.
The maximum value of candidates of P_{rsvp_prs} is equal to or larger than the minimum value of candidates of SL-PRS period.
The maximum value of candidates of P_{rsvp_prs} is equal to or larger than the maximum value of candidates of SL-PRS period.
P_{rsvp_prs} is a multiple of the SL-PRS period. Some or all of candidates of P_{rsvp_prs} are multiple of candidates of SL-PRS periods. For example, candidates of SL-PRS periods are {10, 20} slots, P_{rsvp_prs} are M=2 times of SL-PRS periods, i.e., {20, 40}. For another example, candidates of SL-PRS periods are {10, 20} slots, P_{rsvp_prs} are M=3 times of SL-PRS period 10, and M=1 time of SL-PRS period 20, i.e., {30, 20}.

It is noted that SL-PRS can refer to SL-PRS resource or SL-PRS resource set or SL-PRS configuration or SL-PRS resource pool.

Because of separate sets of resource reservation periods for PSCCH and/or PSSCH as described above, two real sensing windows or durations can be supported for PSCCH/PSSCH with and without scheduling SL-PRS, respectively. For UE1 which transmits a PSCCH and/or PSSCH scheduling a SL-PRS, the candidate P_{rsvp_prs} in the second set can be used for PSCCH/PSSCH sensing. For UE1 which transmits a PSCCH and/or PSSCH without scheduling a data, the candidate P_{rsvp_prs} in the first set is used for PSCCH/PSSCH sensing. Furthermore, two sets of parameters can be preconfigured or configured for resource selection for PSCCH/PSSCH with and without scheduling SL-PRS, respectively. Hence, UE behavior for sensing and/or resource selection can be independent.

To avoid collisions between two PSCCH/PSSCH transmission in the selection window from two UEs, the UEs should consider all the sets of candidate resource reservation periods for PSCCH and/or PSSCH transmission with and without scheduling SL-PRS for partial sensing.

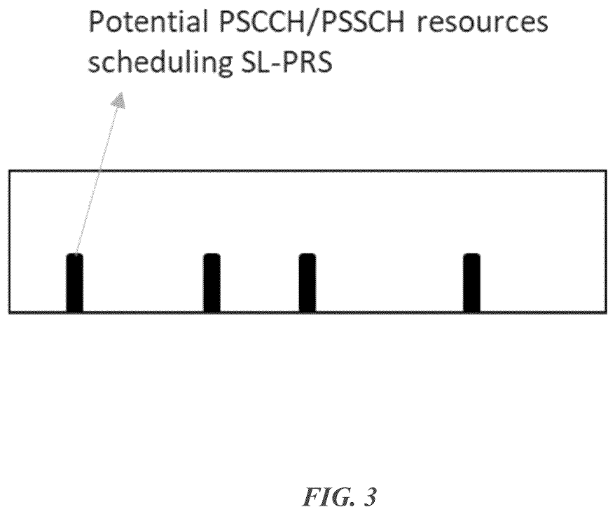

For saving UE power, a subset of slots or logic slots or a subset of resources for potential PSCCH/PSSCH with scheduling SL-PRS can be configured or preconfigured. In other words, the candidate sensing occasions for a sidelink communication resource selection with scheduling SL-PRS is a subset of the candidate sensing occasions for the sidelink communication resource selection without scheduling SL-PRS. The subset of resources can be in the frequency domain or the time domain for a resource pool for sensing and/or resource selection as shown in FIG. 3, where one slot is used for potential PSCCH/PSSCH with scheduling SL-PRS and the remaining slots are for potential PSCCH/PSSCH without scheduling SL-PRS. Alternatively, the candidate sensing slots for PSCCH/PSSCH with scheduling SL-PRS and without SL-PRS can be separate.

In some example embodiment, two sets of parameters are preconfigured or configured for sidelink transmissions with and/or without scheduling SL-PRS. The parameters include: periodicities of the sidelink transmission, sensing window size parameters (e.g., T0), selection window parameters (e.g., T2), priority indicators, CBR related parameters, power control related parameters. The UE can perform sensing or resource selection separately for sidelink transmissions (PSCCH and/or PSSCH) with and without scheduling SL-PRS.

### Example 3

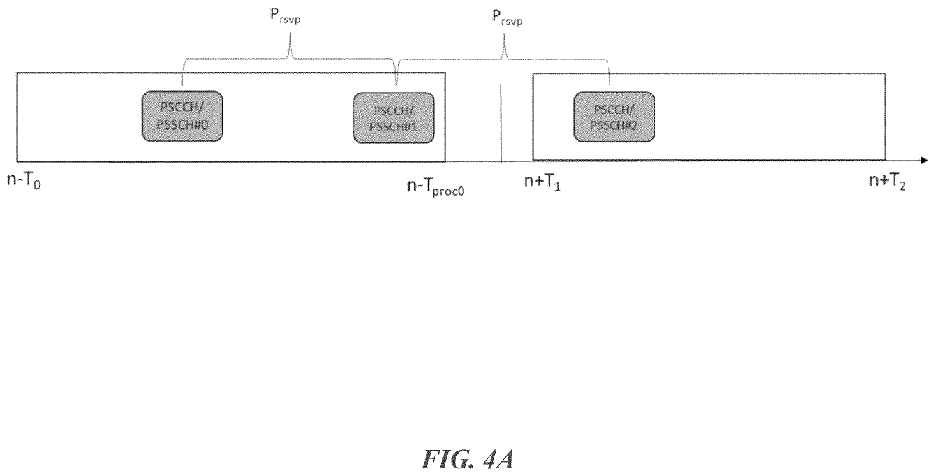

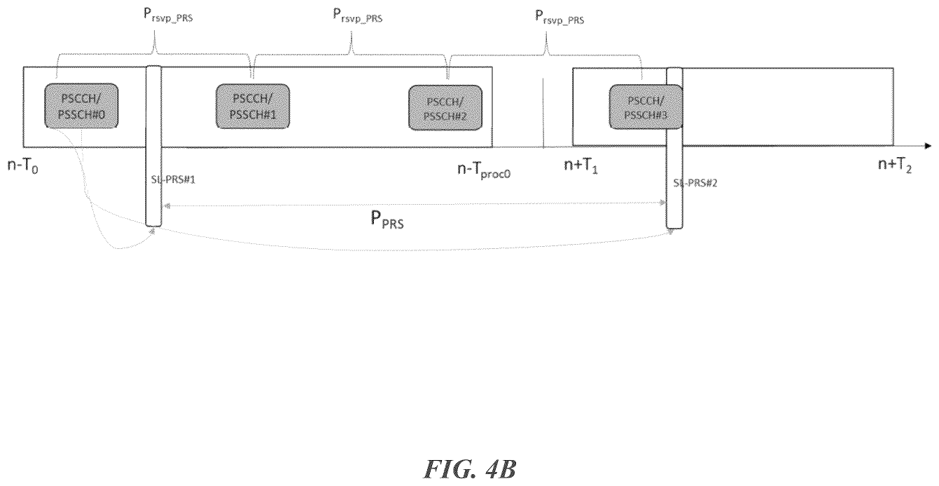

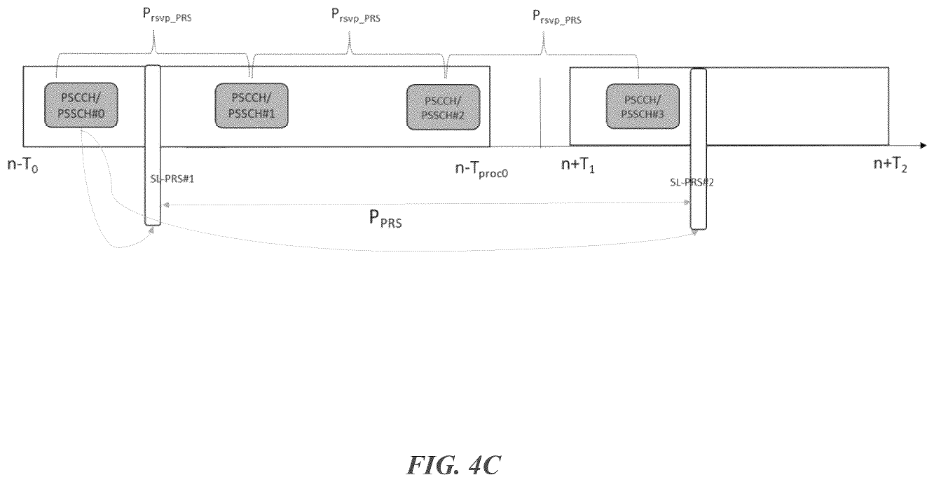

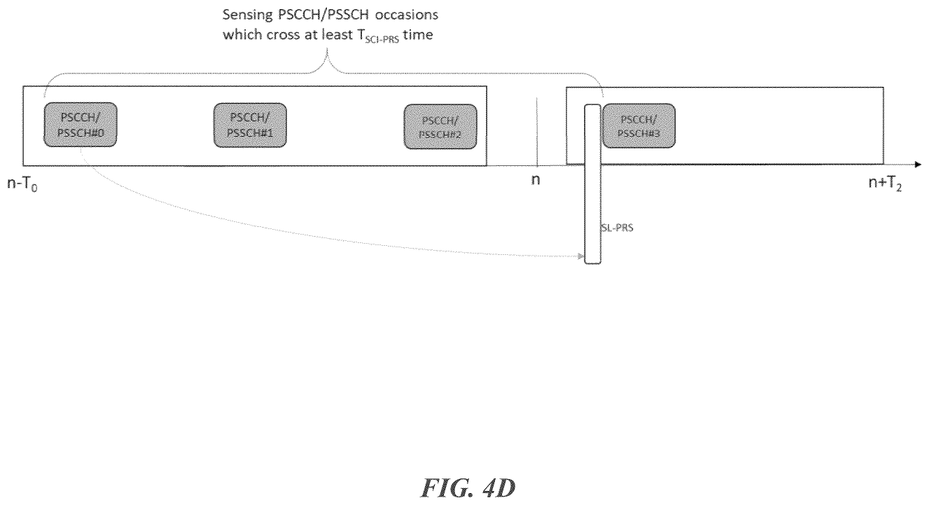

To reduce UE power for sensing, for a candidate resource in the selection window, e.g., PSCCH/PSSCH #2 which would be used for SL-PRS scheduling as shown in FIG. 4A, the UE only needs to perform sensing in the slots corresponding to the most recent sensing occasion (PSSCH #1) for a given reservation periodicity before the resource (re)selection trigger slot n or the first slot of the set of candidate slots (the slot in PSCCH #2), and the last periodic sensing occasion (PSSCH #0) prior to the most recent one for the given reservation periodicity Pᵣₛᵥₚ. That is, Nsense=2. This design is called as partial sensing or periodic based partial sensing solution 1 as UE just needs to sense two periodic occasions before the potential selecting resources for regular data transmission.

If one PSCCH/PSSCH can schedule multiple instances of periodic SL-PRS transmission as shown in FIG. 2D, the partial sensing solution 1 may have some challenges in some scenarios. For example, as shown in FIG. 4B, for a potential resource PSCCH/PSSCH #3 in the selection window which may be used for the SL PSCCH/PSSCH transmission with or without scheduling SL-PRS, if the UE1 only do sensing the resource PSCCH/PSSCH #2 and #1 (not sensing PSCCH/PSSCH #0), the UE1 may determine the resource of PSCCH/PSSCH #3 is available if it does not detect the real transmission in PSCCH/PSSCH #2 and #1 from another UE2. Then the UE1 will transmit PSCCH/PSSCH #3. However, in such case, another UE2 may use PSCCH/PSSCH #0 to reserve SL-PRS #1 and SL-PRS #2 as shown in the figure, then the collision happens between the SL-PRS #2 and the PSCCH/PSSCH #3.

Similarly, as shown in FIG. 4C, if the UE1 does not perform sensing for PSCCH/PSSCH #0, the UE1 may use PSCCH/PSSCH #3 to schedule a SL-PRS which may collide with SL-PRS #2. If a collision occurs between the UE1 and UE2 transmissions, interference will be caused. Further, UE1 and UE2 may not be able to measure the SL-PRS of each other if they don't support full duplex (transmit and receive simultaneously).

Assuming the maximum interval between the scheduling PSCCH/PSSCH and the last one of X scheduled SL-PRS is T_{SCI-PRS}. To avoid the above collision issues, UE1 has to do sensing periodic occasions at least T_{SCI-PRS} before a potential SL-PRS which may be scheduled by a potential candidate PSCCH/PSSCH resource or before the slot n (or logic slot of slot n) or before a potential candidate PSCCH/PSSCH resource as shown in FIG. 4D where T_{SCI-PRS} should be equal or less than the sensing length or duration. The sensing length refers to the time interval from the farthest sensing PSCCH/PSSCH occasion to the resource (re)selection trigger slot n or the first slot of the set of candidate slots (the slot in PSCCH #3). FIG. 4D shows a partial sensing with considering scheduling SL-PRS, the sensing length should be equal or larger than T_{SCI-PRS}. Alternatively, the sensing duration corresponds to a quantity of sidelink communication occasions or a sensing time duration. T_{SCI-PRS} can be preconfigured or configured for each resource pool of sidelink communication or for each interval value between the successive sidelink communication occasions or for each PRS configuration or for each SL-PRS period value.

In summary, the sensing length (duration) Lₛₑₙₛₑ or the number of sensing occasions Nₛₑₙₛₑ is determined at least by T_{SCI-PRS}. T_{SCI-PRS} can be preconfigured or configured for each resource pool or for each PRS configuration or for each SL-PRS period value.

In some cases, in partial sensing for resource reselection, two types of Lₛₑₙₛₑ or Nₛₑₙₛₑ are supported where the first type is for PSCCH/PSSCH without scheduling SL-PRS, e.g., Nₛₑₙₛₑ=2. The second type is for PSCCH/PSSCH with scheduling SL-PRS, e.g., Lₛₑₙₛₑ or Nₛₑₙₛₑ=3 is pre(configured) by higher layer signaling. Alternatively, Lₛₑₙₛₑ for the second type is equal or larger than T_{SCI-PRS}.

In some cases, in partial sensing for resource (re)selection, Nₛₑₙₛₑ is used for PSCCH/PSSCH without scheduling SL-PRS, e.g., Nₛₑₙₛₑ=2. Lₛₑₙₛₑ is used for PSCCH/PSSCH with scheduling SL-PRS, e.g., Lₛₑₙₛₑ is pre(configured) by higher layer signaling. Alternatively, Lₛₑₙₛₑ for the second type is equal or larger than T_{SCI-PRS}.

In some cases, Lₛₑₙₛₑ is at least determined by one or some or all of Nₛₑₙₛₑ, P_{PRS} and X.

### Example 4

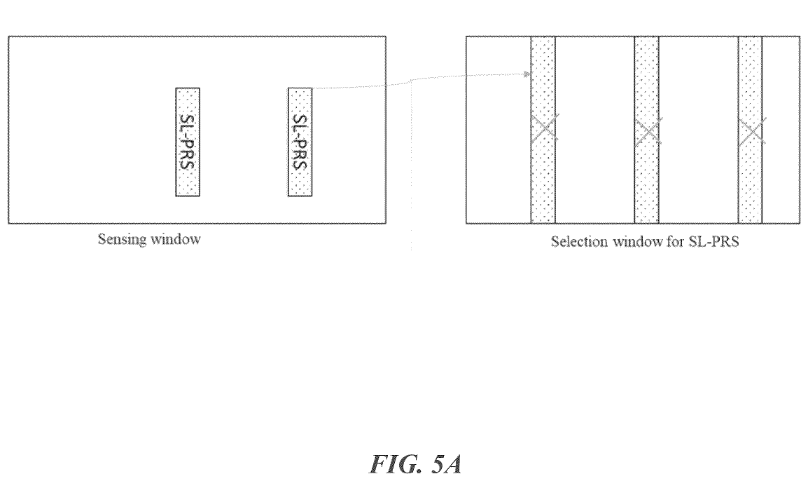

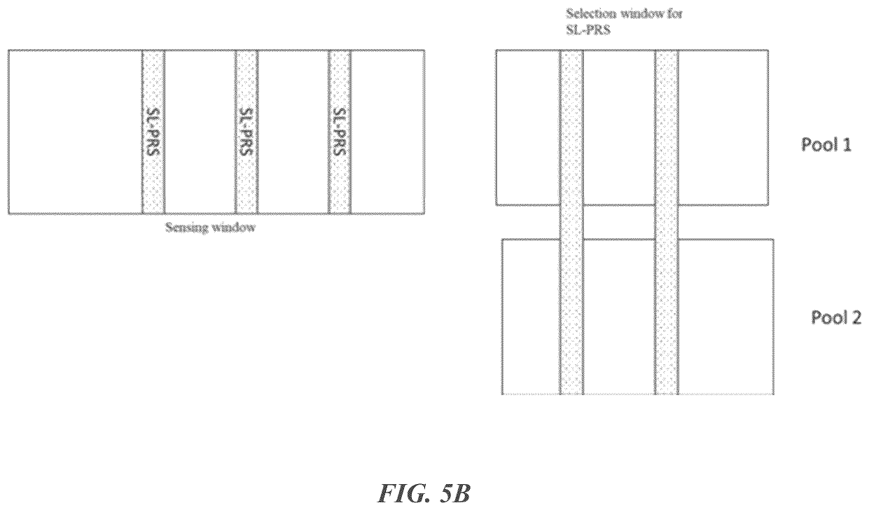

In some scenarios, the UE should also do sensing for SL-PRS. For SL-PRS sensing, a preconfigured or a configured subset of SL-PRS for sensing can be used. The receiving configuration is mapped to the transmit configuration. One or more of the following conditions will be present: 1) only sensing a subset of preconfigured or configured SL-PRS; 2) only a subset of preconfigured or configured SL-PRS resource sets is sensed. For example, if the UE receives RSSI/RSRP/etc. in the subset of SL-PRS resources is larger than a threshold, all resources are not available in the selection window; 3) SL-PRS symbols of a resource or of each resource where only a subset SL-PRS symbols of preconfigured or configured SL-PRS resources is sensed. For example, for a SL-PRS resource preconfigured or configured with X symbols, UE only senses X1<X SL-PRS symbols in the sensing window or duration, if UE determines X1 symbols are not available based on the sensing results, then all corresponding X symbols are unavailable for SL-PRS resource selection; 4) frequency resources of each SL-PRS resource or resource set or SL-PRS configuration where only a subset SL-PRS frequency resources of preconfigured or configured SL-PRS resources is sensed. For example, for a SL-PRS resource preconfigured or configured with X PRBs, UE only senses X1<X PRSs in the sensing window or duration, if UE determines X1 PRBs are not available for its potential SL-PRS transmission, then all corresponding X PRBs are unavailable for its potential SL-PRS transmission, e.g. as shown in FIG. 4-1, if UE receives RSSI/RSRP/etc. in the subset of those sensing PRBs is larger than a threshold, the whole PRS symbol/resource is not available in the selection window, or in another example shown in FIG. 5B where SL-PRS is configured across multiple resource pools in frequency domain. For sensing, UE only needs to monitor/sense PSCCH and/or PSSCH, and/or SL-PRS in a subset of the multiple resource pools in the sensing window. If UE determines the SL-PRS resource in the sensed resource pool(s) is unavailable, UE excludes the corresponding SL-PRS in all of multiple resource pools for the potential transmission candidates. In the figure, UE only do sensing in the first resource pool, if it detects SL-PRS scheduled by other UEs in the first pool, the corresponding SL-PRS resource in the both resource pool 1 and 2 are excluded in the selection window. FIG. 5A shows an example of partial sensing for SL-PRS. FIG. 5B shows an example of partial frequency sensing for SL-PRS between different resource pools. In summary of some aspects of the disclosed subject matter, the UE performs sensing on a subset of SL-PRS configurations or sidelink communications, based on the sensing results, if UE determines the subset of sidelink communication resources or SL-PRS configurations is not available, then the full set of SL-PRS configurations is determined to be unavailable. In this document, the sidelink communication refers to PSCCH or PSSCH or some sidelink transmission other than SL-PRS.

From the foregoing, it will be appreciated that specific embodiments of the invention have been described herein for purposes of illustration, but that various modifications may be made without deviating from the scope of the invention. Accordingly, the invention is not limited except as by the appended claims.

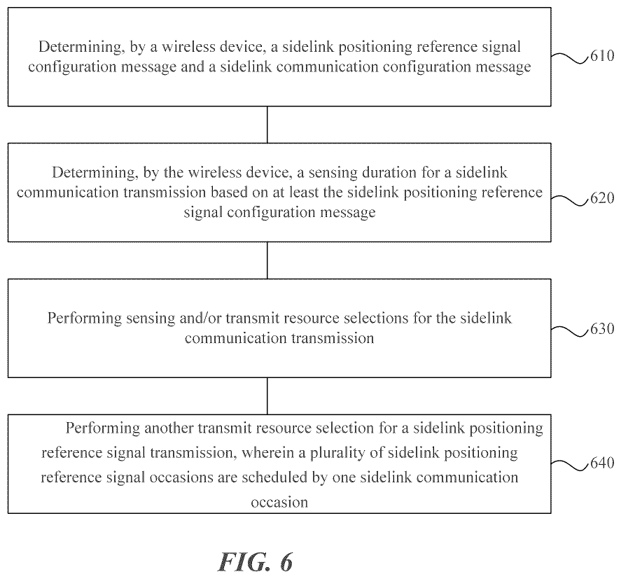

FIG. 6 depicts a process, in accordance with some example embodiments. At 610, the process includes determining, by a wireless device, a sidelink positioning reference signal configuration message and a sidelink communication configuration message. At 620, the process includes determining, by the wireless device, a sensing duration for a sidelink communication transmission based on at least the sidelink positioning reference signal configuration message. At 630, the process includes performing sensing and/or transmit resource selections for the sidelink communication transmission. At 640, the process includes performing another transmit resource selection for a sidelink positioning reference signal transmission, wherein a plurality of sidelink positioning reference signal occasions are scheduled by one sidelink communication occasion.

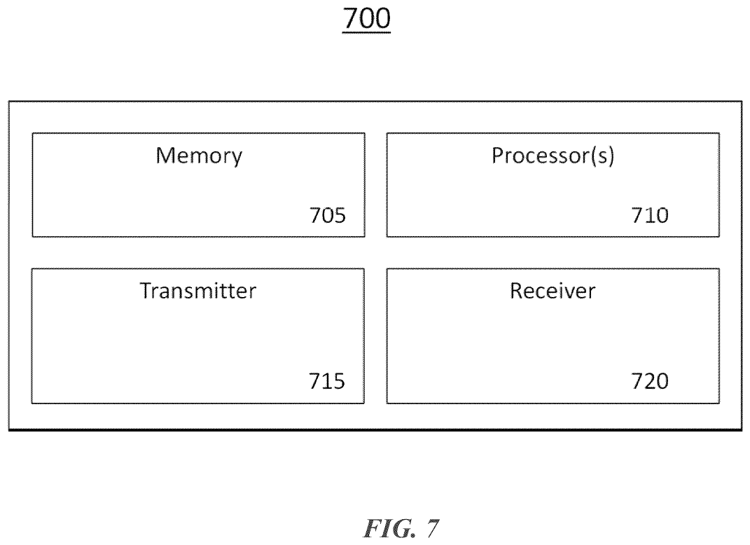

FIG. 7 shows an exemplary block diagram of a hardware platform 700 that may be a part of a network device (e.g., base station) or a communication device (e.g., a wireless device such as a user equipment (UE)). The hardware platform 700 includes at least one processor 710 and a memory 705 having instructions stored thereupon. The instructions upon execution by the processor 710 configure the hardware platform 700 to perform the operations described in FIGS. 1 to 6 in the various embodiments described in this patent document. The transmitter 715 transmits or sends information or data to another device. For example, a network device transmitter can send a message to a user equipment. The receiver 720 receives information or data transmitted or sent by another device. For example, a user equipment can receive a message from a network device.

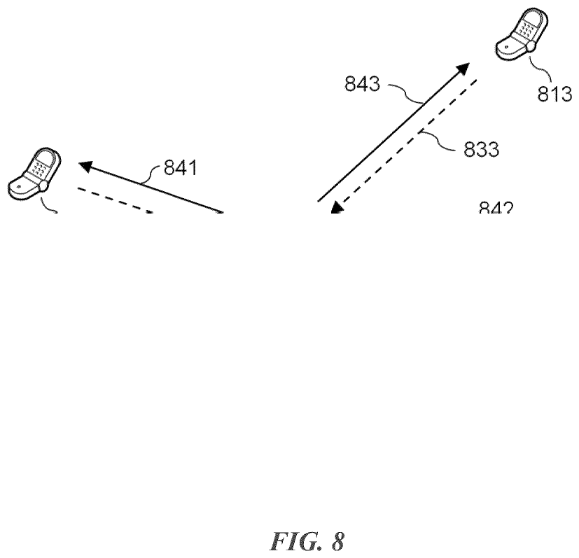

FIG. 8 shows an example of a wireless communication system (e.g., a 5G or NR cellular network) that includes a base station 820 and one or more user equipment (UE) 811, 812 and 813. In some embodiments, the UEs access the BS (e.g., the network) using a communication link to the network (sometimes called uplink direction, as depicted by dashed arrows 831, 832, 833), which then enables subsequent communication (e.g., shown in the direction from the network to the UEs, sometimes called downlink direction, shown by arrows 841, 842, 843) from the BS to the UEs. In some embodiments, the BS send information to the UEs (sometimes called downlink direction, as depicted by arrows 841, 842, 843), which then enables subsequent communication (e.g., shown in the direction from the UEs to the BS, sometimes called uplink direction, shown by dashed arrows 831, 832, 833) from the UEs to the BS. Examples of sidelink communications directly between UEs is shown at 845. Sidelink communications mat be unidirectional from one UE to another (not shown) or bidirectional (shown). UEs may be within sidelink communication range to some UEs and not others due to the distance being too large. The UE may be, for example, a smartphone, a tablet, a mobile computer, a machine to machine (M2M) device, an Internet of Things (IoT) device, and so on.

The following clauses reflect features of some preferred embodiments.

Clause 1. A method of wireless communication, comprising: determining, by a wireless device, a sidelink positioning reference signal configuration message and a sidelink communication configuration message; determining, by the wireless device, a sensing duration for a sidelink communication transmission based on at least the sidelink positioning reference signal configuration message; performing sensing and/or transmit resource selection for the sidelink communication transmission; and performing another transmit resource selection for a sidelink positioning reference signal transmission, wherein a plurality of sidelink positioning reference signal occasions are scheduled by one sidelink communication occasion.

Clause 2. The method of clause 1, wherein the sensing duration corresponds to a quantity of sidelink communication occasions or a sensing time duration.

Clause 3. The method of clause 1, wherein a first interval between successive sidelink communication occasions is determined by at least a second interval between the successive sidelink positioning reference signal occasions, or the second interval between the successive sidelink positioning reference signal occasions is determined by at least the first interval between the successive sidelink communication occasions

Clause 4. The method of clause 3, wherein one or more of: the first interval is equal or smaller than the sensing duration; the first interval is larger than the second interval; the first interval is a multiple of the second interval; or a first interval value has a one-to-one mapping to a second interval value.

Clause 5. The method of clause 2, further comprising: determining a maximum interval, T_{SCI-PRS}, between a sidelink communication occasion and a last one of the plurality of sidelink positioning reference signal occasions scheduled by the sidelink communication occasion based on preconfiguration or a configuration message.

Clause 6. The method of clause 5, wherein the maximum interval, TSCI-PRS, is equal to or less than the sensing duration or a first interval between successive sidelink communication occasions.

Clause 7. The method of clause 1, wherein the performing sensing and/or transmit resource selection for a sidelink communication occasion is determined by whether the sidelink communication triggers a sidelink positioning reference signal.

Clause 8. The method of clause 7, wherein the sensing duration for a first sidelink communication is preconfigured or configured without triggering the sidelink positioning reference signal and a second sidelink communication with triggering the sidelink positioning reference signal are separate.

Clause 9. The method of clause 8, wherein separate candidate interval values between successive sidelink communication occasions are preconfigured or configured for a first sidelink communication without triggering sidelink positioning reference signal and a second sidelink communication with triggering sidelink positioning reference signal.

Clause 10. The method of clause 7, wherein candidate sensing occasions for a sidelink communication resource selection with scheduling SL-PRS is a subset of the candidate sensing occasions for the sidelink communication resource selection without scheduling SL-PRS.

Clause 11. The method of clause 5, wherein partial periodic sensing is operated at least a time, T_{SCI-PRS}, before a potential SL-PRS selection occasion scheduled by a potential sidelink communication selection occasion or before a slot triggering a selection procedure or before a potential sidelink communication selection occasion scheduling the SL-PRS selection occasion.

Clause 12. The method of clause 5, wherein T_{SCI-PRS} is preconfigured or configured for each resource pool of sidelink communication or for each interval value between the successive sidelink communication occasions or for each PRS configuration or for each SL-PRS period value.

Clause 13. The method of clause 5 or 12, wherein the sensing duration is equal or longer than T_{SCI-PRS}.

Clause 14. The method of clause 1, further comprising: determining, by the wireless device, a subset of SL-PRS configurations for sensing, or determining a sidelink communication time or frequency configuration scheduling SL-PRS for sensing based on preconfiguration or a configuration message, wherein a full set of SL-PRS configurations is determined to be unavailable according to the sensing result for the subset.

Clause 15. The method 14, wherein the configuration includes one or more of: SL-PRS symbols in one SL-PRS resource; frequency resources in each SL-PRS symbol; or resources in one SL-PRS resource set.

Clause 16. Another wireless device in sidelink communication with the wireless device can perform another method including one or more of transmitting the sidelink positioning reference signal configuration message and/or the sidelink communication configuration message; transmitting preferred sensing and transmit resource selection for the sidelink communication transmission. The other wireless device may perform various combinations of features detailed in clauses 2-15.

From the foregoing, it will be appreciated that specific embodiments of the presently disclosed technology have been described herein for purposes of illustration, but that various modifications may be made without deviating from the scope of the invention. Accordingly, the presently disclosed technology is not limited except as by the appended claims.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

1. A method of wireless communication, comprising:
determining, by a wireless device, a sidelink positioning reference signal configuration message and a sidelink communication configuration message;
determining, by the wireless device, a sensing duration for a sidelink communication transmission based on at least the sidelink positioning reference signal configuration message;
performing sensing or transmit resource selection for the sidelink communication transmission; and
performing another transmit resource selection for a sidelink positioning reference signal transmission, wherein a plurality of sidelink positioning reference signal occasions are scheduled by one sidelink communication occasion.

2. The method of claim 1, wherein the sensing duration corresponds to a quantity of sidelink communication occasions or a sensing time duration.

3. The method of claim 1, wherein a first interval between successive sidelink communication occasions is determined by at least a second interval between the successive sidelink positioning reference signal occasions, or the second interval between the successive sidelink positioning reference signal occasions is determined by at least the first interval between the successive sidelink communication occasions.

4. The method of claim 3, wherein one or more of:
the first interval is equal or smaller than the sensing duration;
the first interval is larger than the second interval;
the first interval is a multiple of the second interval; or
a first interval value has a one-to-one mapping to a second interval value.

5. The method of claim 2, further comprising:
determining a maximum interval, T_{SCI-PRS}, between a sidelink communication occasion and a last one of the plurality of sidelink positioning reference signal occasions scheduled by the sidelink communication occasion based on preconfiguration or a configuration message.

6. The method of claim 5, wherein the maximum interval, T_{SCI-PRS}, is equal to or less than the sensing duration or a first interval between successive sidelink communication occasions.

7. The method of claim 1, wherein the performing sensing or transmit resource selection for a sidelink communication occasion is determined by whether the sidelink communication triggers a sidelink positioning reference signal.

8. The method of claim 7, wherein the preconfigured or configured sensing duration for a first sidelink communication occurs without triggering the sidelink positioning reference signal and a second sidelink communication with triggering the sidelink positioning reference signal are separate.

9. The method of claim 8, wherein separate candidate interval values between successive sidelink communication occasions are preconfigured or configured for a first sidelink communication without triggering sidelink positioning reference signal and a second sidelink communication with triggering sidelink positioning reference signal.

10. The method of claim 7, wherein candidate sensing occasions for a sidelink communication resource selection with scheduling SL-PRS is a subset of the candidate sensing occasions for the sidelink communication resource selection without scheduling SL-PRS.

11. The method of claim 5, wherein partial periodic sensing is operated at least a time, T_{SCI-PRS}, before a potential SL-PRS selection occasion scheduled by a potential sidelink communication selection occasion or before a slot triggering a selection procedure or before a potential sidelink communication selection occasion scheduling the SL-PRS selection occasion.

12. The method of claim 5, wherein T_{SCI}-PRS is configured or preconfigured for each resource pool of sidelink communication or for each interval value between the successive sidelink communication occasions or for each PRS configuration or for each SL-PRS period value.

13. The method of claim 5, wherein the sensing duration is equal or longer than T_{SCI-PRS}.

14. The method of claim 1, further comprising:
determining, by the wireless device, a subset of SL-PRS configurations for sensing, or
determining a sidelink communication time or frequency configuration scheduling SL-PRS for sensing based on a preconfiguration or configuration message, wherein a full set of SL-PRS configurations is determined to be unavailable according to the sensing result for the subset.

15. The method of claim 14, wherein the configuration comprises one or more of:
SL-PRS symbols in one SL-PRS resource;
frequency resources in each SL-PRS symbol; or
resources in one SL-PRS resource set.

16. An apparatus for wireless communication, comprising at least one processor configured to cause the apparatus to perform, wherein the method comprises:
determining, by a wireless device, a sidelink positioning reference signal configuration message and a sidelink communication configuration message:
determining, by the wireless device, a sensing duration for a sidelink communication transmission based on at least the sidelink positioning reference signal configuration message:
performing sensing or transmit resource selection for the sidelink communication transmission; and
performing another transmit resource selection for a sidelink positioning reference signal transmission, wherein a plurality of sidelink positioning reference signal occasions are scheduled by one sidelink communication occasion.

17. A non-transitory computer-readable medium having processor-executable code stored thereon, the code, upon execution by at least one processor of an apparatus, causing the apparatus to, wherein the method comprises perform:
determining, by a wireless device, a sidelink positioning reference signal configuration message and a sidelink communication configuration message:
determining, by the wireless device, a sensing duration for a sidelink communication transmission based on at least the sidelink positioning reference signal configuration message:
performing sensing or transmit resource selection for the sidelink communication transmission; and
performing another transmit resource selection for a sidelink positioning reference signal transmission, wherein a plurality of sidelink positioning reference signal occasions are scheduled by one sidelink communication occasion.

18. The apparatus of claim 16, wherein the sensing duration corresponds to a quantity of sidelink communication occasions or a sensing time duration.

19. The apparatus of claim 16, wherein a first interval between successive sidelink communication occasions is determined by at least a second interval between the successive sidelink positioning reference signal occasions, or the second interval between the successive sidelink positioning reference signal occasions is determined by at least the first interval between the successive sidelink communication occasions.

20. The apparatus of claim 16, wherein one or more of:
the first interval is equal or smaller than the sensing duration;
the first interval is larger than the second interval;
the first interval is a multiple of the second interval; or
a first interval value has a one-to-one mapping to a second interval value.
